(19) United States
(12) Patent Application Publication
(10) Pub. No.: US 2026/0261963 A1
(43) Pub. Date: Sep. 3, 2026

(54) RADIO COMMUNICATION SYSTEM, TERMINAL APPARATUS, BASE STATION APPARATUS, CONTROL APPARATUS, AND RADIO COMMUNICATION METHOD SELECTION METHOD

(71) Applicant: NTT, Inc., Tokyo (JP)

(72) Inventors: Toshiro NAKAHIRA, Tokyo (JP); Ryota SHIINA, Tokyo (JP); Tatsuhiko IWAKUNI, Tokyo (JP); Takuto ARAI, Tokyo (JP)

(21) Appl. No.: 18/873,484

(22) PCT Filed: Jul. 11, 2022
(86) PCT No.: PCT/JP2022/027286

§ 371 Date: Dec. 10, 2024

(51) Int. Cl. H04W 48/18

(52) U.S. Cl. CPC H04W 48/18

(57) ABSTRACT

A radio communication system includes: an information acquisition unit that acquires radio communication method characteristics for each radio communication method and communication request characteristics of a terminal apparatus; and a selection unit that calculates, for each radio communication method, an inner product of a first vector whose elements are values of items that constitute the radio communication method characteristics and a second vector whose elements are values of items that constitute the communication request characteristics, and selects a radio communication method of a connection destination of the terminal apparatus, based on a size of the inner product for each radio communication method.

### TECHNICAL FIELD

The present invention relates to a technique for selecting a radio communication method to be used, from among a plurality of radio communication methods.

### BACKGROUND ART

Recent terminal apparatuses are capable of selecting a radio communication method to be used from among a plurality of radio communication methods. In a radio communication system, communication quality and communication performance in a terminal apparatus largely depend on the radio communication method of a base station apparatus to which the terminal apparatus connects.

### CITATION LIST

### Non-Patent Literature

NPL 1: Ono et al., “[Invited lecture] Performance evaluation on QoS Prediction between Terminals and Access Points Using Convolutional Neural Network,” IEICE Technical Report, vol. 121, No. 301, NS2021-108, pp. 59-64, December 2021

### SUMMARY OF INVENTION

### Technical Problem

There are differences in communication characteristics between a plurality of radio communication methods. Therefore, it is preferable that a terminal apparatus connect to a base station apparatus that supports a radio communication method according to (suitable for) communication requirements of the terminal apparatus, and communicate with the base station apparatus using this radio communication method.

However, the related art such as NPL 1 does not take into account differences in communication characteristics between radio communication methods. Therefore, when a terminal apparatus uses a radio communication method selected in the related art, sufficient communication quality might not be obtained.

The present invention has been made in view of the above points, and an object of the present invention is to provide a technique that makes it possible to select a radio communication method according to communication requirements of a terminal apparatus while considering communication characteristics of each radio communication method in a radio communication system in which a plurality of radio communication methods are used.

### Solution to Problem

According to the disclosed technique, there is provided a radio communication system including: an information acquisition unit that acquires radio communication method characteristics for each radio communication method and communication request characteristics of a terminal apparatus; and a selection unit that calculates, for each radio communication method, an inner product of a first vector whose elements are values of items that constitute the radio communication method characteristics and a second vector whose elements are values of items that the constitute communication request characteristics, and selects a radio communication method of a connection destination of the terminal apparatus, based on a size of the inner product for each radio communication method.

### Advantageous Effects of Invention

According to the disclosed technique, a technique is provided that makes it possible to select a radio communication method according to communication requirements of a terminal apparatus while considering communication characteristics of each radio communication method in a radio communication system in which a plurality of radio communication methods are used.

### BRIEF DESCRIPTION OF DRAWINGS

FIG. 1 is a diagram illustrating an example of an overall configuration of a radio communication system.

FIG. 2 is a diagram showing radio communication method characteristics and communication request characteristics.

FIG. 3 is a sequence diagram of a first operation example.

FIG. 4 is a sequence diagram of a second operation example.

FIG. 5 is a sequence diagram of a third operation example.

FIG. 6 is a diagram illustrating a first configuration example.

FIG. 7 is a diagram illustrating a second configuration example.

FIG. 8 is a diagram illustrating a third configuration example.

FIG. 9 is a diagram illustrating an example of a hardware configuration of a device.

### DESCRIPTION OF EMBODIMENTS

An embodiment of the present invention (present embodiment) will be described below with reference to the drawings. The embodiment to be described below is merely an example, and embodiments to which the present invention is applied are not limited to the embodiment to be described below.

### Overview of Embodiment

As mentioned above, there are differences in communication characteristics between a plurality of radio communication methods. Therefore, it is preferable that a terminal apparatus connect to a base station apparatus that supports a radio communication method according to (suitable for) communication requirements of the terminal apparatus, and communicate with the base station apparatus using this radio communication method.

For example, high frequency bands such as millimeter waves have high throughput and are less susceptible to unexpected radio wave interference from the surroundings, but are susceptible to shielding. On the other hand, microwave bands are less affected by shielding because the radio waves diffract, but are susceptible to unexpected radio wave interference from the surroundings.

When a base station apparatus having a radio communication method that uses a millimeter wave band and a base station apparatus having a radio communication method that uses a microwave band are available, due to the above-mentioned difference in communication characteristics, it is preferable that a terminal apparatus that is expected to be used in an environment with many shielding objects connect to a base station apparatus having a radio communication method that uses a microwave band. In the present embodiment, it is possible to automatically select such a radio communication method based on the communication characteristics of each radio communication method and the communication requirements of the terminal apparatus.

Hereinafter, a technique that makes it possible to select a radio communication method according to the communication requirements of a terminal apparatus while considering the communication characteristics of each radio communication method will be described in detail.

### Example of Overall Configuration of System

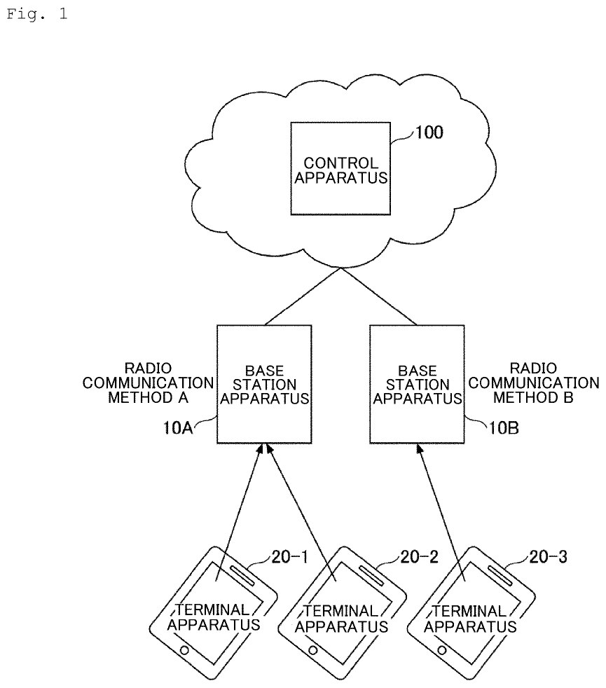

FIG. 1 illustrates an example of an overall configuration of a radio communication system according to the present embodiment. The radio communication system in the present embodiment includes a plurality of base station apparatuses 10, a plurality of terminal apparatuses 20, and a control apparatus 100. The control apparatus 100 may be provided in a core network of a mobile network, may be provided on the Internet, or may be provided in a network other than these.

The plurality of base station apparatuses 10 include two base station apparatuses having different radio communication methods. Note that the radio communication system need not include the control apparatus 100.

In FIG. 1, a base station apparatus 10A that supports a radio communication method A and a base station apparatus 10B that supports a radio communication method B are illustrated as examples of two base station apparatuses 10 having different radio communication methods. The two different radio communication methods may be different in any way.

For example, the two different radio communication methods may be a cellular scheme (e.g., 3G, 4G/LTE, 5G, or 6G) and a wireless LAN, may use different bands (e.g., a high frequency band and a low frequency band), may have different generations of wireless access schemes (e.g., 4G and 5G), may have different core networks (e.g., EPC and 5GC) connected to the base station apparatus, may have different supported functions (e.g., with MIMO and without MIMO), or may be different in other ways than these.

Furthermore, even if the two radio communication methods are the same from the above point of view, when the radio communication characteristics are different between two base station apparatuses 10 due to the number of antennas attached to the base station apparatus 10, the wireless parameter settings in the base station apparatus 10, the operation mode settings in the base station apparatus 10, and the like, the two base station apparatuses 10 may be considered to have “different radio communication methods”.

The terminal apparatus 20 connects to and communicates with one base station apparatus 10 by radio. Further, depending on the function of the terminal apparatus 20, the terminal apparatus 20 may connect to and communicate with a plurality of base station apparatuses 10 simultaneously by radio. Further, one base station apparatus 10 may support a plurality of radio communication methods.

### Operation Example of Radio Communication System

An example of the operation of the radio communication system in the present embodiment will be described below. In the present embodiment, the entity that selects a radio communication method to be supported by the base station apparatus 10 that is a connection destination of the terminal apparatus 20 may be any of the terminal apparatus 20, the base station apparatus 10, and the control apparatus 100, and therefore these will be described below as first to third operation examples. In describing the second and third operation examples, the same matters as described in the first operation example are omitted or only briefly described. Note that a “radio communication method to be supported by the base station apparatus 10 that is a connection destination of the terminal apparatus 20” may be rephrased as a “radio communication method of a connection destination of the terminal apparatus 20.”

### <First Operation Example: Selection of Radio Communication Method by Terminal Apparatus 20>

First, the first operation example will be described. In the first operation example, the terminal apparatus 20 selects a radio communication method of its own connection destination.

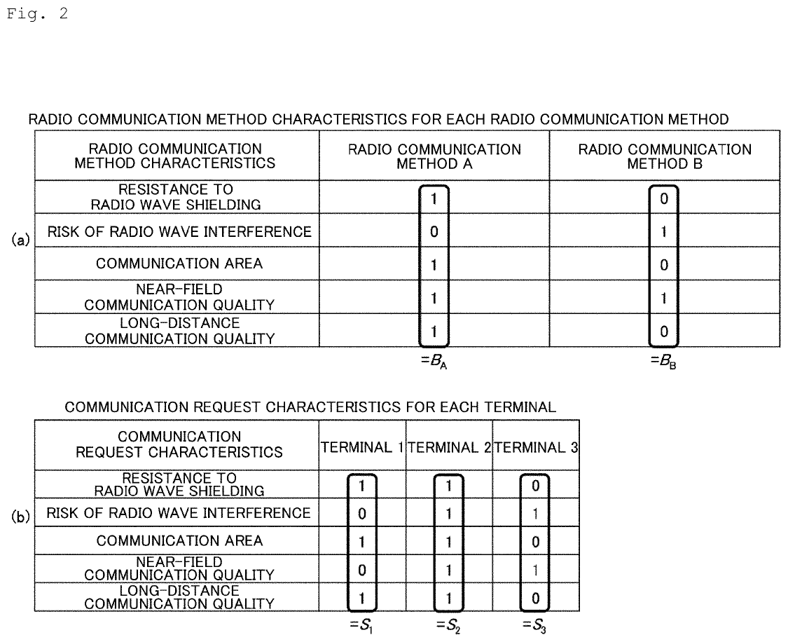

As a premise of the operation here, it is assumed that the control apparatus 100 holds a table that summarizes radio communication method characteristics for each radio communication method, as shown in FIG. 2(a), and a table that summarizes communication request characteristics for each terminal apparatus, as shown in FIG. 2(b). Note that holding this information as a table is an example. It may be held in a format other than a table. Further, the communication request characteristics may also be referred to as communication requirements.

The information shown in FIG. 2 may be collected by any method. For example, the radio communication method characteristics may be manually set in advance by a system administrator for each radio communication method. Alternatively, the control apparatus 100 may collect information regarding radio communication methods from each base station apparatus 10, and calculate radio communication method characteristics for each radio communication method from the collected information. For example, information indicating long-distance communication quality (such as measurement results from a long-distance terminal) is received from the base station apparatus 10 having the radio communication method A, and it is possible to determine whether the long-distance communication quality of the radio communication method A is good or bad from the information.

Further, regarding the communication request characteristics for each terminal apparatus 20, the control apparatus 100 may acquire a user's contract information for each terminal apparatus 20 from a subscriber information database, and calculate (set) the communication request characteristics based on the contract information. Alternatively, the control apparatus 100 may acquire terminal capability information (capability) from the base station apparatus 10 that holds terminal capability information of the terminal apparatus 20, and calculate (set) the communication request characteristics based on the terminal capability information.

Further, regarding the communication request characteristics of the terminal apparatuses 20, each terminal apparatus 20 may hold its own communication request characteristics, instead of these characteristics being held in the control apparatus 100.

In the example shown in FIG. 2, resistance to radio wave shielding, risk of radio wave interference, communication area, near-field communication quality, and long-distance communication quality are used as characteristic items, but these are merely examples, and characteristic items different from these may be used.

In the present embodiment, the items in the radio communication method characteristics and the items in the communication request characteristics are the same, However, this is merely an example, and different items may be included between the items in the radio communication method characteristics and the items in the communication request characteristics. In this case, in the inner product calculation to be described later, it is sufficient to calculate the product of the same items.

Regarding the radio communication method characteristics, “1” in “resistance to radio wave shielding” indicates that there is resistance to radio wave shielding, and “0” indicates that there is no resistance. “1” in “risk of radio wave interference” indicates that there is no risk of radio wave interference, and “0” indicates that there is a risk. “1” in “communication area” indicates that the communication area is wide, and “0” indicates that it is narrow. “1” in “near-field communication quality” indicates that the near-field communication quality is good, and “0” indicates that the near-field communication quality is poor. “1” in “long-distance communication quality” indicates that the long-distance communication quality is good, and “0” indicates that the long-distance communication quality is poor.

Regarding the communication request characteristics of the terminal apparatus 20, “1” in “resistance to radio wave shielding” indicates that resistance to radio wave shielding is required, and “0” indicates that resistance is not required. “1” in “risk of radio wave interference” indicates that the risk of radio wave interference is not allowed, and “0” indicates that the risk is allowed. “1” in “communication area” indicates that the communication area needs to be wide, and“0” indicates that the communication area may be narrow. “1” in “near-field communication quality” indicates that the near-field communication quality needs to be good, and “0” indicates that the near-field communication quality does not need to be good. “1” in “long-distance communication quality” indicates that the long-distance communication quality needs to be good, and “0” indicates that the long-distance communication quality does not need to be good.

That is, in the example shown in FIG. 2, “1” in the radio communication method characteristics for a certain item indicates a preferable radio communication method characteristic when the communication request characteristic is “1.”

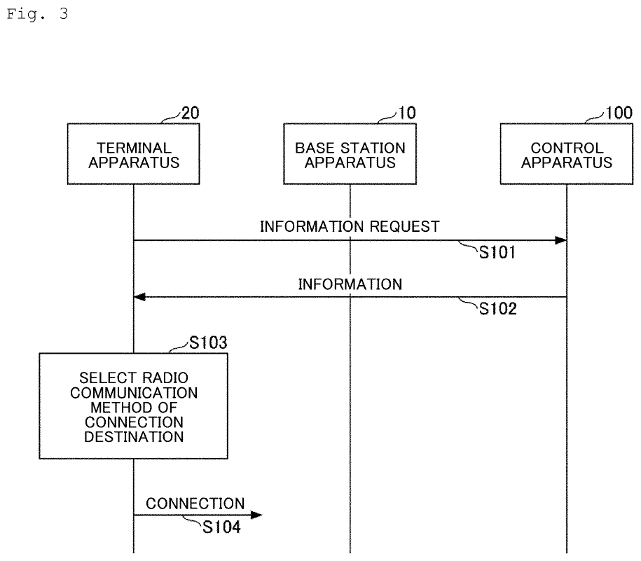

The first operation example will be described with reference to the sequence shown in FIG. 3. When the terminal apparatus 20 connects to the wireless network, the terminal apparatus 20 first transmits an information request to the control apparatus 100 in S101, and acquires information from the control apparatus 100 in S102. Note that, regarding the base station apparatus 10 used at this time, for example, a base station apparatus 10 having any available radio communication method may be used.

The information acquired in S102 is the radio communication method characteristics for each radio communication method shown in FIG. 2(a) and the communication request characteristics for the target terminal apparatus 20.

In S103, the terminal apparatus 20 selects the radio communication method of the connection destination based on the information acquired in S102. In S104, the terminal apparatus 20 connects to the base station apparatus 10 that supports the selected radio communication method. Note that the terminal apparatus 20 can determine which base station apparatus 10 supports which radio communication method, for example, from the system information broadcast from each base station apparatus 10. Details of the radio communication method selection method in S103 are as follows.

The terminal apparatus 20 calculates an inner product of the radio communication method characteristics and its own communication request characteristics for each radio communication method. That is, the inner product of a vector in which the values of items of radio communication method characteristics are arranged and a vector in which values of items of communication request characteristics are arranged is calculated.

The terminal apparatus 20 selects a radio communication method corresponding to the largest inner product among the inner products calculated for each radio communication method, as the radio communication method of the connection destination. By selecting the radio communication method with the largest inner product, the radio communication method that best satisfies the communication request characteristics of the terminal apparatus 20 can be selected.

For example, in the example of FIG. 2, it is assumed that “terminal 1” is the target terminal apparatus 20. At this time, since B_{A}·S₁=3 and B_{B}·S₁=0, the terminal apparatus 20 selects the radio communication method A as the radio communication method of the connection destination.

Select a radio communication method corresponding to the largest inner product among the inner products calculated for each radio communication method as described above is one example. As another example, the terminal apparatus 20 may select any radio communication method from among N radio communication methods whose inner-product sizes correspond to the top N inner products among the inner products calculated for each radio communication method. Here, N is an integer of 2 or more. Furthermore, the terminal apparatus 20 may select N radio communication methods whose sizes correspond to the top N inner products among the inner products calculated for each radio communication method, and perform communication by simultaneously using the N radio communication methods. N may be 2, 3, or 4 or more.

Further, in order to consider the case where a plurality of connection destinations (radio communication methods) are simultaneously used, evaluation may be performed using an inner product after adding a column for the case where a plurality of radio communication methods are used simultaneously to “radio communication method characteristics for each radio communication method” (table shown in FIG. 2(a)). For example, in the table shown in FIG. 2(a), a column for “radio communication method A+B” is provided. Assuming that the vector of this column is (1, 1, 1, 1, 1), the scheme that maximizes the inner product for terminal 2 is “radio communication method A+B.”

In addition, although the values for each item in “radio communication method characteristics for each radio communication method” and “communication request characteristics for each terminal apparatus” are set to take a binary value of 0 or 1 in the above example, the present invention is not limited thereto.

As a value P for each item in “radio communication method characteristics for each radio communication method” and “communication request characteristics for each terminal apparatus,” continuous values satisfying 0≤P≤1 may be used, and the weights may be set flexibly. For example, items with high importance are set to take a value close to 1.

Furthermore, a value exceeding 1 may be set as the value P for each item in “radio communication method characteristics for each radio communication method” and “communication request characteristics for each terminal apparatus”.

Further, a value less than 0 may be set as the value P for each item in “radio communication method characteristics for each radio communication method” and “communication request characteristics for each terminal apparatus.” This allows a “negative evaluation” to be made for the item.

### <Second Operation Example: Selection of Radio Communication Method by Base Station Apparatus 10>

Next, the second operation example will be described. In the second operation example, the base station apparatus 10 selects a radio communication method of a connection destination of the terminal apparatus 20.

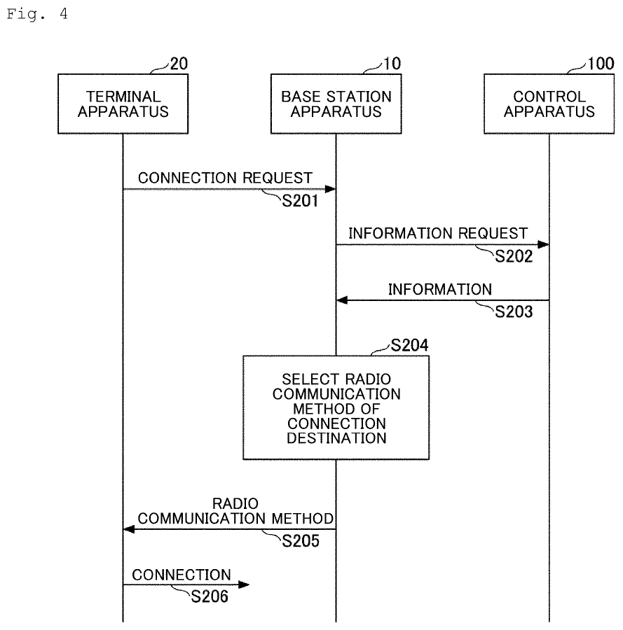

The second operation example will be described with reference to the sequence diagram shown in FIG. 4. As a premise of the second operation example, it is assumed that, similarly to the first operation example, the table shown in FIG. 2 is stored in the control apparatus 100.

In S201, the terminal apparatus 20 transmits a connection request to the base station apparatus 10. Regarding the base station apparatus 10 used at this time, for example, a base station apparatus 10 having any available radio communication method may be used.

In S202, the base station apparatus 10 transmits an information request to the control apparatus 100, and in S203, acquires information from the control apparatus 100.

The information acquired in S203 is the radio communication method characteristics for each radio communication method shown in FIG. 2(a) and the communication request characteristics for the target terminal apparatus 20.

In S204, the base station apparatus 10 selects a radio communication method of a connection destination of the terminal apparatus 20 based on the information acquired in S203. The selection method is as described in the first operation example.

In S205, the base station apparatus 10 notifies the terminal apparatus 20 about the selected radio communication method. This notification includes, for example, a command instructing connection to the base station apparatus 10 having the selected radio communication method.

In S206, the terminal apparatus 20 connects to the base station apparatus 10 that supports the radio communication method notified from the base station apparatus 10.

### <Third Operation Example: Selection of Radio Communication Method by Control Apparatus 100>

Next, the third operation example will be described. In the third operation example, the control apparatus 10 selects a radio communication method of a connection destination of the terminal apparatus 20.

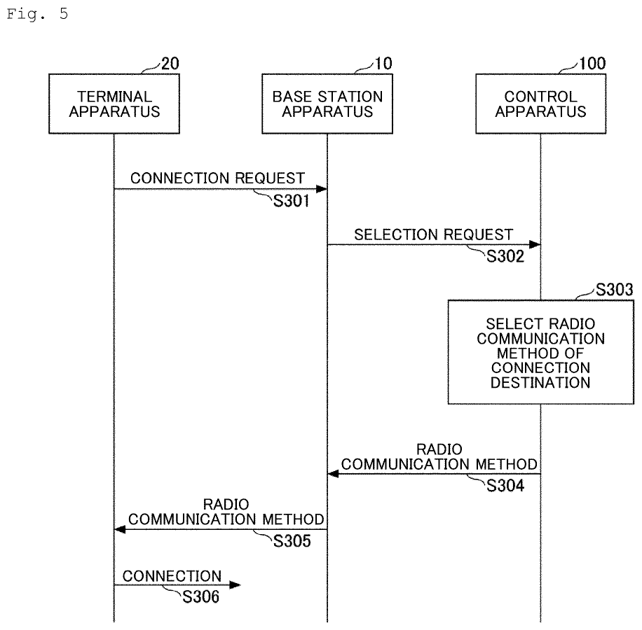

The third operation example will be described with reference to the sequence diagram shown in FIG. 5. As a premise of the third operation example, it is assumed that, similarly to the first operation example, the table shown in FIG. 2 is stored in the control apparatus 100.

In S301, the terminal apparatus 20 transmits a connection request to the base station apparatus 10. Regarding the base station apparatus 10 used at this time, for example, a base station apparatus 10 having any available radio communication method may be used.

In S302, the base station apparatus 10 transmits a selection request to the control apparatus 100 to request selection of a radio communication method for the terminal apparatus 20.

In S303, the control apparatus 100 selects a radio communication method of a connection destination of the terminal apparatus 20 based on the radio communication method characteristics for each radio communication method and the communication request characteristics for the target terminal apparatus 20. The selection method is as described in the first operation example.

In S304, the control apparatus 100 notifies the base station apparatus 10 that is a request source about the selected radio communication method. In S305, the base station apparatus 10 notifies the terminal apparatus 20 about the selected radio communication method. This notification includes, for example, a command instructing connection to the base station apparatus 10 having the selected radio communication method. In S306, the terminal apparatus 20 connects to the base station apparatus 10 that supports the radio communication method notified from the base station apparatus 10.

### Example of Device Configuration

Next, an example of the configuration of a device constituting the radio communication system will be described. In each of the following examples, the configuration of a device particularly related to the operation of selecting a radio communication method is shown in detail.

### <Configuration Example Corresponding to First Operation Example (First Configuration Example)>

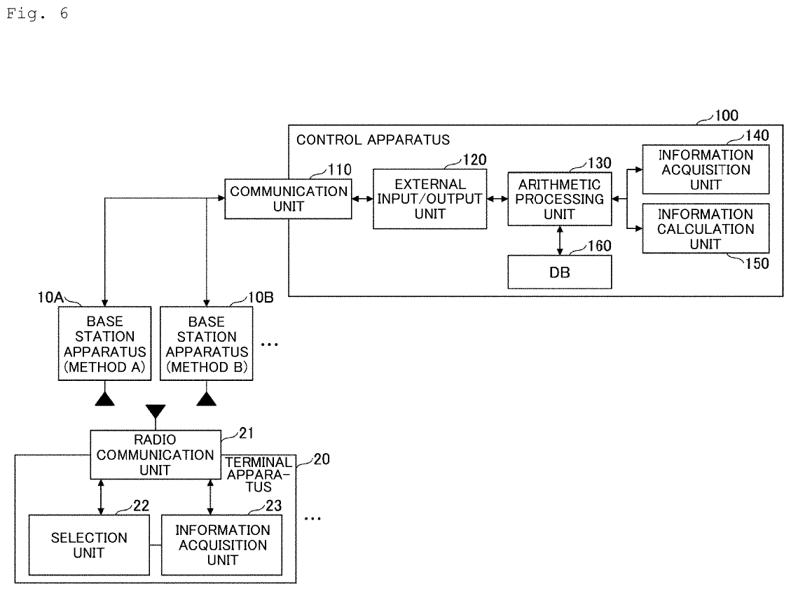

FIG. 6 shows a first configuration example, which is a configuration example in the first operation example (when the terminal apparatus 20 selects a radio communication method).

As shown in FIG. 6, the control apparatus 100 in the first configuration example includes a communication unit 110, an external input/output unit 120, an arithmetic processing unit 130, an information acquisition unit 140, an information calculation unit 150, and a database (DB) 160.

The communication unit 110 connects to a network and performs information communication. The external input/output unit 120 passes information received via the communication unit 110 to the arithmetic processing unit 130, and outputs information received from the arithmetic processing unit 130 to the outside via the communication unit 110.

The arithmetic processing unit 130 performs, for example, storing information in the DB 160 and reading information from the DB 160.

The information acquisition unit 140 acquires information from the outside via the communication unit 110, the external input/output unit 120, and the like. For example, the information acquisition unit 140 acquires, from each base station apparatus 10 under the control of the control apparatus 100, information regarding the radio communication method supported by that base station apparatus 10. Further, the information acquisition unit 140 can also acquire capability information of each terminal apparatus 20 from each base station apparatus 10 under the control of the control apparatus 100.

The information calculation unit 150 calculates information on radio communication method characteristics based on the information regarding the radio communication method acquired from each base station apparatus 10, and stores the calculated information in the DB 160. The information calculation unit 150 can also calculate the communication request characteristics of each terminal apparatus 20 based on the capability information of each terminal apparatus 20, and store the calculated communication request characteristics in the DB 160.

Note that, without using the information calculation unit 150, the information acquisition unit 140 may acquire the radio communication method characteristics for radio communication method and the communication request characteristics for each terminal apparatus 20 from the outside, and store the acquired information in the DB 160.

Further, when receiving a request from the outside to acquire information such as radio communication method characteristics for each radio communication method, for example, the arithmetic processing unit 130 reads the information from the DB 160 and transmits the information to the outside.

The terminal apparatus 20 includes a radio communication unit 21, a selection unit 22, and an information acquisition unit 23. The radio communication unit 21 communicates with the base station apparatus 10 by radio. The information acquisition unit 23 acquires information necessary for selecting a radio communication method (radio communication method characteristics for each radio communication method, communication request characteristics of the terminal apparatus 20) from the control apparatus 100. Further, when the terminal apparatus 20 holds the communication request characteristics of the terminal apparatus 20 in a storage unit such as a memory, the information acquisition unit 23 acquires the communication request characteristics from the storage unit.

The selection unit 22 selects (determines) a radio communication method of a connection destination of the terminal apparatus 20 based on the information acquired by the information acquisition unit 23. The selection method is as described above. That is, the selection unit 21 calculates, for each radio communication method, an inner product of a first vector whose elements are values of items that constitute radio communication method characteristics and a second vector whose elements are values of items that constitute communication request characteristics, and selects a radio communication method to be supported by the base station apparatus 10 that is a connection destination of the terminal apparatus 20 based on the size of the inner product for each radio communication method.

### <Configuration Example Corresponding to Second Operation Example (Second Configuration Example)>

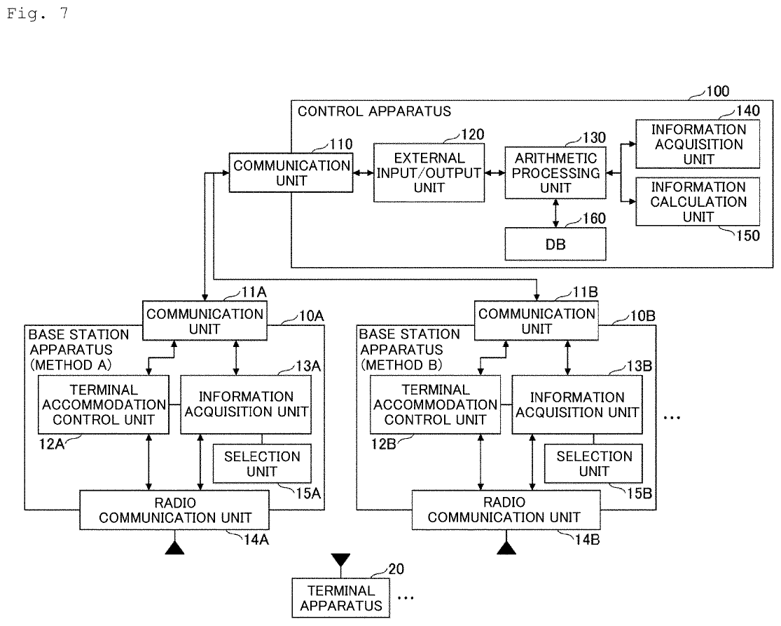

FIG. 7 shows a second configuration example, which is a configuration example in the second operation example (when the base station apparatus 10 selects a radio communication method). The configuration of the control apparatus 100 in the second configuration example is the same as the configuration of the control apparatus 100 in the first configuration example. Regarding the base station apparatus 10, since the base station apparatuses 10A and 10B have the same configuration, A and B will be described below without distinction.

The base station apparatus 10 includes a communication unit 11, a terminal accommodation control unit 12, an information acquisition unit 13, a radio communication unit 14, and a selection unit 15. The communication unit 11 performs information communication via a network. The radio communication unit 14 communicates with the terminal apparatus 20 by radio. The information acquisition unit 13 acquires information necessary for selecting a radio communication method (radio communication method characteristics for each radio communication method, communication request characteristics of the terminal apparatus 20) from the control apparatus 100. Further, when the terminal apparatus 20 holds the communication request characteristics of the terminal apparatus 20 in a storage unit such as a memory, the information acquisition unit 13 acquires the communication request characteristics from the terminal apparatus 20.

The terminal accommodation control unit 12 performs control for accommodating the terminal apparatus 20, such as receiving a connection request from the terminal apparatus 20 and returning a response signal to the terminal apparatus 20. The response signal may be “a command instructing connection to the base station apparatus 10 having the selected radio communication method”, as described above.

The selection unit 15 selects (determines) a radio communication method of a connection destination of the terminal apparatus 20, based on the information acquired by the information acquisition unit 13. The selection method is as described above. That is, the selection unit 15 calculates, for each radio communication method, an inner product of a first vector whose elements are values of items that constitute radio communication method characteristics and a second vector whose elements are values of items that constitute communication request characteristics, and selects a radio communication method to be supported by the base station apparatus that is a connection destination of the terminal apparatus 20, based on the size of the inner product for each radio communication method.

### <Configuration Example Corresponding to Third Operation Example (Third Configuration Example)>

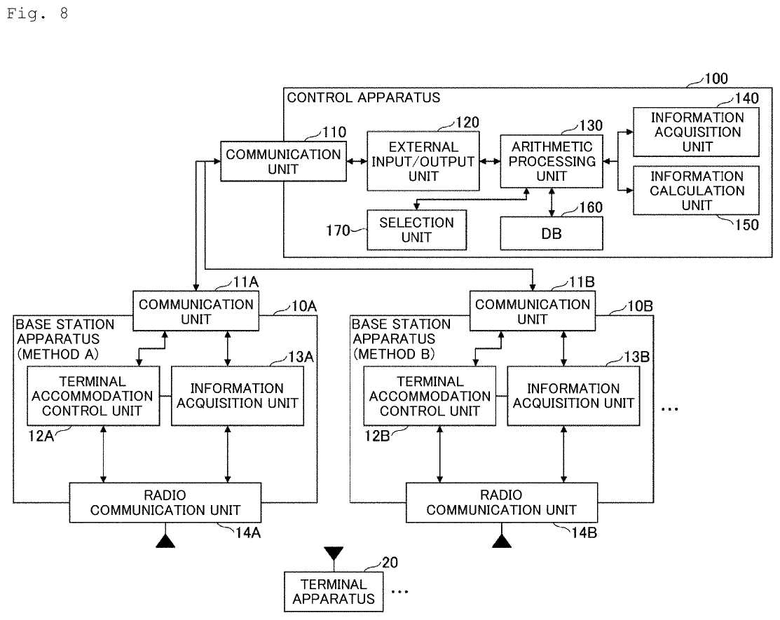

FIG. 8 shows a third configuration example, which is a configuration example in the third operation example (when the control apparatus 100 selects a radio communication method).

The configuration of the control apparatus 100 in the third configuration example is such that a selection unit 170 is added to the configuration of the control apparatus 100 in the first configuration example (and the second configuration example). The configuration of the base station apparatus 10 is the same as the configuration of the base station apparatus 10 in the second configuration example except that the selection unit 15 is removed.

In the control apparatus 100, the information acquisition unit 140 acquires information necessary for selecting a radio communication method (radio communication method characteristics for each radio communication method, communication request characteristics of the terminal apparatus 20) from the DB 160. Further, when the terminal apparatus 20 holds the communication request characteristics of the terminal apparatus 20 in a storage unit such as a memory, the information acquisition unit 140 acquires the communication request characteristics from the terminal apparatus 20.

The selection unit 170 selects (determines) a radio communication method of a connection destination of the terminal apparatus 20 based on the information acquired by the information acquisition unit 140. The selection method is as described above. That is, the selection unit 170 calculates, for each radio communication method, an inner product of a first vector whose elements are values of items that constitute radio communication method characteristics and a second vector whose elements are values of items that constitute communication request characteristics, and selects a radio communication method to be supported by the base station apparatus that is a connection destination of the terminal apparatus 20 based on the size of the inner product for each radio communication method. The selection unit 170 notifies the base station apparatus 10 about the selected radio communication method. The base station apparatus 10 transmits, to the terminal apparatus 20, “a command instructing connection to the base station apparatus 10 having the selected radio communication method”.

### Example of Hardware Configuration

The terminal apparatus 20, the base station apparatus 10, and the control apparatus 100 can all be implemented, for example, by causing a computer to execute a program. This computer may be a physical computer, or may be a virtual machine on a cloud. Hereinafter, the “terminal apparatus 20, the base station apparatus 10, and the control apparatus 100” are collectively referred to as the “device”.

Specifically, the device can be implemented by executing a program corresponding to the processing to be performed in the device, using hardware resources such as a CPU and a memory built into the computer. The program can be stored and distributed by being recorded in a computer-readable recording medium (portable memory or the like). Furthermore, the program can also be provided through a network such as the Internet or an electronic mail.

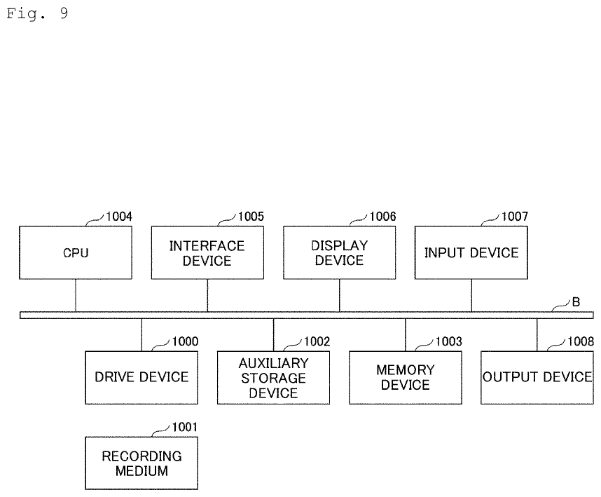

FIG. 9 is a diagram illustrating an example of a hardware configuration of the computer. The computer illustrated in FIG. 9 includes a drive device 1000, an auxiliary storage device 1002, a memory device 1003, a CPU 1004, an interface device 1005, a display device 1006, an input device 1007, an output device 1008, and the like, which are connected to each other via a bus BS.

The program for implementing the processing in the computer is provided by, for example, a recording medium 1001 such as a CD-ROM or a memory card. When the recording medium 1001 in which the program is stored is set in the drive device 1000, the program is installed from the recording medium 1001 to the auxiliary storage device 1002 through the drive device 1000. However, the program need not necessarily be installed from the recording medium 1001, and may be downloaded from another computer via a network. The auxiliary storage device 1002 stores the installed program and stores necessary files, data, and the like.

When an activation instruction for the program is given, the memory device 1003 reads out the program from the auxiliary storage device 1002 and stores the program. The CPU 1004 implements a function related to the device in accordance with a program stored in the memory device 1003.

The interface device 1005 is used as an interface for connection to a network or the like. The display device 1006 displays a graphical user interface (GUI) or the like based on a program. The input device 1007 includes a keyboard and mouse, buttons, a touch panel, or the like, and is used to input various operation instructions. The output device 1008 outputs a calculation result.

Note that the device need not include any one, any plurality, or all of the display device 1006, the input device 1007, and the output device 1008.

### Summary of Embodiments, Effect

As described above, with the technique according to the present embodiment, it is possible to select a base station apparatus that is a connection destination of the radio communication method, based on the radio communication method characteristics summarized in advance for each radio communication method and the communication request characteristics of the terminal apparatus itself. Accordingly, it is possible to select a radio communication method according to communication requirements of a terminal apparatus while considering communication characteristics of each radio communication method in a radio communication system in which a plurality of radio communication methods are used. Furthermore, the expected communication quality can be obtained, and communication requirements can be more easily satisfied.

### Supplementary Notes

The present specification discloses at least the radio communication system, terminal apparatus, base station apparatus, control apparatus, and radio communication method selection method of each of the following Supplementary Notes.

### (Supplementary Note 1)

A radio communication system including:
a memory; and at least one processor connected to the memory, in which the processor is configured to: acquire radio communication method characteristics for each radio communication method and communication request characteristics of a terminal apparatus; and calculate, for each radio communication method, an inner product of a first vector whose elements are values of items that constitute radio communication method characteristics and a second vector whose elements are values of items that constitute communication request characteristics, and select a radio communication method of a connection destination of the terminal apparatus based on a size of the inner product for each radio communication method.

### (Supplementary Note 2)

The radio communication system according to Supplementary Note 1, in which the processor selects a radio communication method corresponding to a largest inner product among the inner products for each radio communication method as the radio communication method of the connection destination of the terminal apparatus.

### (Supplementary Note 3)

The radio communication system according to Supplementary Note 1 or 2, in which the radio communication method of the connection destination of the terminal apparatus includes a plurality of radio communication methods.

### (Supplementary Note 4)

A terminal apparatus in a radio communication system including a base station apparatus and the terminal apparatus, the terminal apparatus including: a memory; and at least one processor connected to the memory, in which the processor is configured to: acquire radio communication method characteristics for each radio communication method and communication request characteristics of the terminal apparatus; and calculate, for each radio communication method, an inner product of a first vector whose elements are values of items that constitute radio communication method characteristics and a second vector whose elements are values of items that constitute communication request characteristics, and select a radio communication method of a connection destination of the terminal apparatus based on a size of the inner product for each radio communication method.

### (Supplementary Note 5)

A base station apparatus in a radio communication system including the base station apparatus and a terminal apparatus, the base station apparatus including: a memory; and at least one processor connected to the memory, in which the processor is configured to: acquire radio communication method characteristics for each radio communication method and communication request characteristics of the terminal apparatus; and calculate, for each radio communication method, an inner product of a first vector whose elements are values of items that constitute radio communication method characteristics and a second vector whose elements are values of items that constitute communication request characteristics, and select a radio communication method of a connection destination of the terminal apparatus based on a size of the inner product for each radio communication method.

### (Supplementary Note 6)

A control apparatus that controls a radio communication system including a base station apparatus and a terminal apparatus, the control apparatus including: a memory; and at least one processor connected to the memory, in which the processor is configured to: acquire radio communication method characteristics for each radio communication method and communication request characteristics of the terminal apparatus; and calculate, for each radio communication method, an inner product of a first vector whose elements are values of items that constitute radio communication method characteristics and a second vector whose elements are values of items that constitute communication request characteristics, and select a radio communication method of a connection destination of the terminal apparatus based on a size of the inner product for each radio communication method.

### (Supplementary Note 7)

A radio communication method selection method executed by one or more computers constituting a radio communication system, the radio communication method selection method including: an information acquisition step of acquiring radio communication method characteristics for each radio communication method and communication request characteristics of a terminal apparatus; and a selection step of calculating, for each radio communication method, an inner product of a first vector whose elements are values of items that constitute radio communication method characteristics and a second vector whose elements are values of items that constitute communication request characteristics, and selecting a radio communication method of a connection destination of the terminal apparatus based on a size of the inner product for each radio communication method.

Although the present embodiment has been described above, the present invention is not limited to such a specific embodiment, and various modifications and changes can be made within the scope of the gist of the present invention described in the claims.

### REFERENCE SIGNS LIST

10 Base station apparatus
11 Communication unit
12 Terminal accommodation control unit
13 Information acquisition unit
14 Radio communication unit
15 Selection unit
20 Terminal apparatus
21 Radio communication unit
22 Selection unit
23 Information acquisition unit
100 Control apparatus
110 Communication unit
120 External input/output unit
130 Arithmetic processing unit
140 Information acquisition unit
150 Information calculation unit
160 DB
170 Selection unit
1000 Drive device
1001 Recording medium
1002 Auxiliary storage device
1003 Memory device
1004 CPU
1005 Interface device
1006 Display device
1007 Input device
1008 Output device

1. A radio communication system comprising:
a processor; and
a memory that includes instructions, which when executed, cause the processor to execute:
acquiring radio communication method characteristics for each radio communication method and communication request characteristics of a terminal apparatus; and
calculating, for each radio communication method, an inner product of a first vector whose elements are values of items that constitute the radio communication method characteristics and a second vector whose elements are values of items that constitute the communication request characteristics, and selecting a radio communication method of a connection destination of the terminal apparatus, based on a size of the inner product for each radio communication method.

2. The radio communication system according to claim 1, wherein the selecting includes selecting a radio communication method corresponding to a largest inner product among the inner products for each radio communication method, as the radio communication method of the connection destination of the terminal apparatus.

3. The radio communication system according to claim 1, wherein the radio communication method of the connection destination of the terminal apparatus includes a plurality of radio communication methods.

4. A terminal apparatus in a radio communication system including a base station apparatus and the terminal apparatus, the terminal apparatus comprising:
a processor; and
a memory that includes instructions, which when executed, cause the processor to execute:
acquiring radio communication method characteristics for each radio communication method and communication request characteristics of the terminal apparatus; and
calculating, for each radio communication method, an inner product of a first vector whose elements are values of items that constitute the radio communication method characteristics and a second vector whose elements are values of items that constitute the communication request characteristics, and selecting a radio communication method of a connection destination of the terminal apparatus, based on a size of the inner product for each radio communication method.

5. A base station apparatus in a radio communication system including the base station apparatus and a terminal apparatus, the base station apparatus comprising:
a processor; and
a memory that includes instructions, which when executed, cause the processor to execute:
an acquiring radio communication method characteristics for each radio communication method and communication request characteristics of the terminal apparatus; and
calculating, for each radio communication method, an inner product of a first vector whose elements are values of items that constitute the radio communication method characteristics and a second vector whose elements are values of items that constitute the communication request characteristics, and selecting a radio communication method of a connection destination of the terminal apparatus, based on a size of the inner product for each radio communication method.

6. A control apparatus that controls a radio communication system including a base station apparatus and a terminal apparatus, the control apparatus comprising:
a processor; and
a memory that includes instructions, which when executed, cause the processor to execute:
an information acquiring radio communication method characteristics for each radio communication method and communication request characteristics of the terminal apparatus; and
calculating, for each radio communication method, an inner product of a first vector whose elements are values of items that constitute the radio communication method characteristics and a second vector whose elements are values of items that constitute the communication request characteristics, and selecting a radio communication method of a connection destination of the terminal apparatus, based on a size of the inner product for each radio communication method.

7. A radio communication method selection method executed by one or more computers constituting a radio communication system, the radio communication method selection method comprising:
acquiring radio communication method characteristics for each radio communication method and communication request characteristics of a terminal apparatus; and
calculating, for each radio communication method, an inner product of a first vector whose elements are values of items that constitute the radio communication method characteristics and a second vector whose elements are values of items that constitute the communication request characteristics, and selecting a radio communication method of a connection destination of the terminal apparatus, based on a size of the inner product for each radio communication method.
